(19) United States
(12) Patent Application Publication
(10) Pub. No.: US 2023/0091316 A1
(43) Pub. Date: Mar. 23, 2023

(54) FLUID DISPENSER AND METHOD OF USE

(71) Applicant: Vaask LLC, Austin, TX (US)

(72) Inventors: Jonathan W.W. Olsen, Austin, TX (US); David Rhodes Banks, Lexington, KY (US)

(21) Appl. No.: 17/942,383

(22) Filed: Sep. 12, 2022

Related U.S. Application Data
(60) Provisional application No. 63/355,221, filed on Jun. 24, 2022.
(60) Provisional application No. 63/245,314, filed on Sep. 17, 2021.

(51) Int. Cl. B05B 11/00; B05B 12/12

(52) U.S. Cl. CPC B05B 11/3052; B05B 12/124

(57) ABSTRACT

A fluid dispenser includes a pump, a motor, a nozzle, a near field sensor, and a controller. The near field sensor is configured to sense a presence of an object within a predetermined distance away from the near field sensor. The controller is configured to determine the presence of the object within the predetermined distance for a first predetermined amount of time. In response to the determination, the controller is configured to activate the pump to push fluid in a first direction. The controller is configured to determine an absence of the object within the predetermined distance of the near field sensor. The controller is configured to reverse operation of the pump for a second predetermined number of rotations to draw the fluid in a second direction that is opposite the first direction in the absence of the object within the predetermined distance of the near field sensor.

### PRIORITY

This application claims the filing benefit of U.S. Provisional Pat. App. No. 63/355,221 entitled “Fluid Dispenser and Method of Use,” filed on Jun. 24, 2022 and U.S. Provisional Pat. App. No. 63/245,314 entitled “Fluid Dispenser and Method of Use,” filed on Sep. 17, 2021, the disclosures of which are incorporated by reference herein.

### BACKGROUND

Fluid dispensers dispense fluids using a wide range of methods. Some fluid dispensers may be manually actuated by a user physically contacting a mechanism (e.g., a lever), while others may be automatically actuated (e.g., using a motor) when a user's hand is sensed by a sensor. For an automatically actuated fluid dispenser, a user may initiate the fluid dispensing operation, only to move their hand away from the fluid dispenser after the fluid dispenser decided to dispense the fluid. This may result in the dispensed fluid being dripped onto a drip tray or the floor. Additionally, at the conclusion of a dispensing cycle, the tail end of the fluid stream may unintentionally drip onto the drip tray or the floor. These drips may be unsightly, require additional maintenance, and potentially result in a slippery surface. As a result, it is desirable to prevent this fluid from being dripped onto the drip tray or the floor.

Additionally, it would be beneficial to draw a user closer to the fluid dispenser, while avoiding background noise (such as movement beyond a predetermined distance). While several fluid dispensers have been made and used, it is believed that no one prior to the inventors has made or used the invention described in the appended claims.

### BRIEF DESCRIPTION OF THE DRAWINGS

The accompanying drawings, which are incorporated in and constitute a part of this specification, illustrate embodiments of the invention, and, together with the general description of the invention given above, and the detailed description of the embodiments given below, serve to explain the principles of the present invention.

FIG. 1 depicts a schematic perspective view of a first exemplary fluid dispenser in a closed configuration prior to insertion into a cavity of a wall, the fluid dispenser including a first exemplary nozzle assembly;

FIG. 2 depicts the fluid dispenser of FIG. 1, but in an open configuration revealing components of a front panel and receptacle of the fluid dispenser;

FIG. 3 depicts a perspective view of select components of the front panel and the receptacle of FIG. 2;

FIG. 4 depicts a side elevation view select components of the receptacle of FIG. 2;

FIG. 5 depicts a side elevation view select components of the front panel of FIG. 2;

FIG. 6 depicts a top plan view of the fluid dispenser of FIG. 1 being coupled with a wall member using coupling features;

FIG. 7 depicts a schematic perspective view of a second exemplary fluid dispenser in a closed configuration prior to insertion onto a stand using coupling features;

FIG. 8 depicts a top perspective view of a second exemplary nozzle assembly;

FIG. 9 depicts a bottom perspective view of the nozzle assembly of FIG. 8;

FIG. 10 depicts a diagrammatic view of a first exemplary method of operating the fluid dispenser of FIG. 1;

FIG. 11 depicts a diagrammatic view of a second exemplary method of operating the fluid dispenser of FIG. 1;

FIG. 12 depicts a diagrammatic view of a third exemplary method of operating the fluid dispenser of FIG. 1;

FIG. 13A shows a schematic sectional view of the sensor of FIG. 3 adjacent tubing, with fluid reaching a first position in the tubing, and with the sensor determining that fluid is absent from the sensing field of the sensor;

FIG. 13B shows a schematic sectional view of the sensor and tubing of FIG. 13A with fluid reaching a second position in the tubing, and with the sensor determining that fluid is present in the sensing field of the sensor;

FIG. 13C shows a schematic sectional view of the sensor and tubing of FIG. 13A, with fluid returning to the first position the tubing, and with the sensor determining that fluid is absent from the sensing field of the sensor;

FIG. 13D shows a schematic sectional view of the sensor and tubing of FIG. 13A, with the fluid filling the tubing, and with the sensor determining that fluid is present in the sensing field of the sensor;

FIG. 14 depicts a schematic view of an exemplary system that includes the fluid dispenser of FIG. 1;

FIG. 15 depicts a first exemplary interface for use with the system of FIG. 14; and

FIG. 16 depicts a second exemplary interface for use with the system of FIG. 14.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

To the extent that spatial terms such as “upper,” “lower,” “vertical,” “horizontal,” or the like are used herein with reference to the drawings, it will be appreciated that such terms are used for exemplary description purposes only and are not intended to be limiting or absolute. In that regard, it will be understood that devices such as those disclosed herein may be used in a variety of orientations and positions not limited to those shown and described herein. Further, the terms “about” and “approximately” as used herein for any numerical values or ranges indicate a suitable dimensional tolerance that allows the part or collection of components to function for its intended purpose as described herein.

I. Exemplary Fluid Dispensers and Methods of Operation

A. First Exemplary Fluid Dispenser

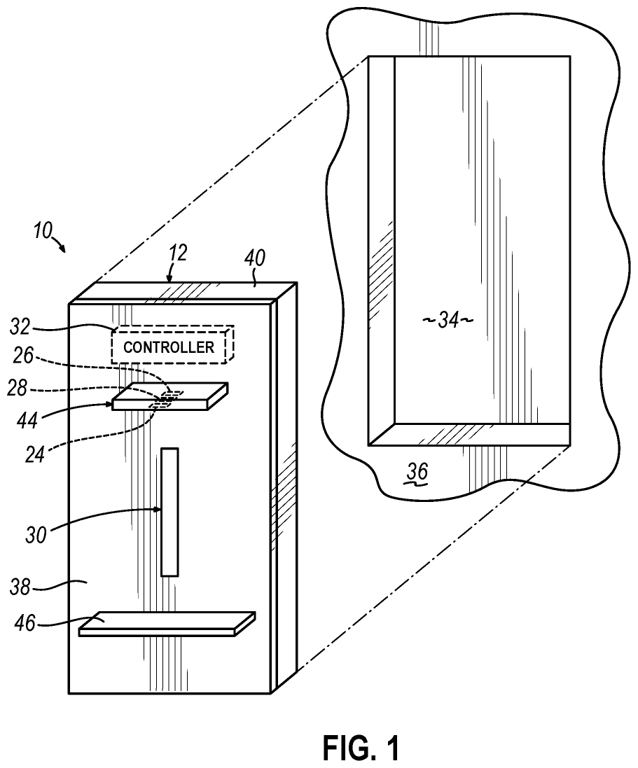

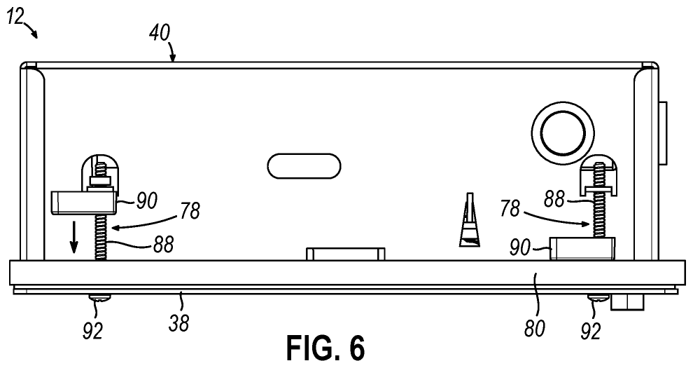

FIGS. 1-6 show a first exemplary fluid dispenser (10). As shown, fluid dispenser (10) includes a body (12), a fluid source (14), a power source (16), a pump (18), a stepper motor (20), tubing (22), a nozzle assembly (24), a near field laser range finder (26), a far field laser range finder (28), a display (30), and a controller (32). In some versions, nozzle assembly (24) may include near field laser range finder (26) and far field laser range finder (28). For example, as shown in FIG. 1, fluid dispenser (10) may be recessed into a cavity (34) of a wall (36). Fluid dispenser (10) is shown as a hand cleaning device that may be built into a building's interior. While fluid dispenser (10) is shown as dispensing a liquid, in some versions, fluid dispenser (10) may be alternatively configured to dispense a foam. Any suitable liquid may be dispensed including hand sanitizer and soap.

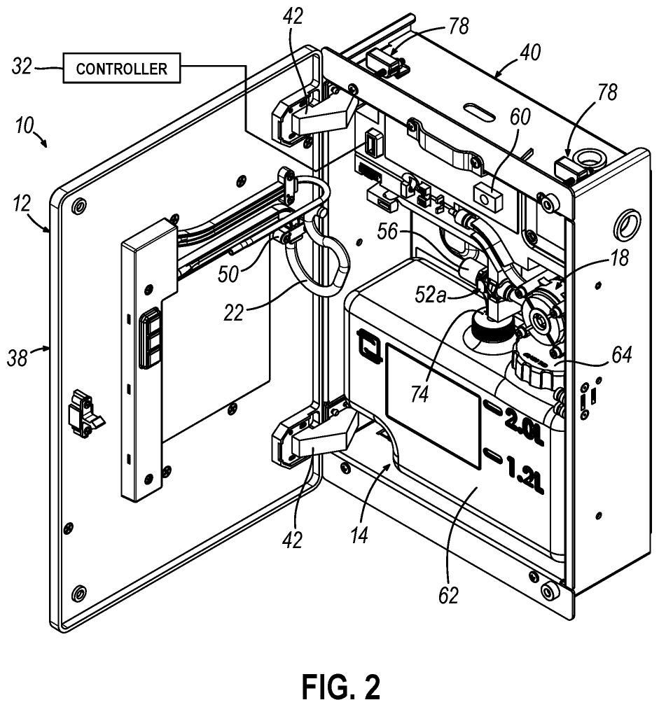

Body (12) includes a front panel (38) and a receptacle (40). Front panel (38) is pivotable relative to receptacle (40), via hinges (42), between a closed configuration (shown schematically in FIG. 1) and an open configuration (FIG. 2). In some versions, body (12) may be formed of cast aluminum. While not shown, indica (e.g., corporate logos) may be positioned on front panel (38). As shown in FIG. 1, an arm (44) and a drip tray (46) extend outwardly from front panel (38). Nozzle assembly (24), near field laser range finder (26), and far field laser range finder (28) are each disposed on arm (44). As shown in FIGS. 1 and 5, front panel (38) includes a display (30) configured to show a message to the user. Examples of such messages may include at least one of a dispensing message, a non-dispensing message, or a low fluid warning. In some versions, display (30) may be used to attract a user to fluid dispenser (10). For example, fluid dispenser (10) may warn the user (which may include a maintenance person) with an orange low bar on display (30) as the empty state approaches. Display (30) may be customized to display a variety of different colors and/or illumination sequence. Receptacle (40) may be recessed into a standard stud-depth wall cavity. Receptacle (40) is configured to house a variety of components including fluid source (14), power source (16), pump (18), stepper motor (20), tubing (22), and controller (32). In some versions, stepper motor (20) and controller (32) may be removed as a single unit for repair or replacement.

Pump (18) is configured to receive fluid from fluid source (14). While pump (18) is shown as a peristaltic pump in FIGS. 2-4, other types of pumps are also envisioned. Pump (18) includes a plurality of rollers (52) that pinch tubing (22) and force a predetermined volume of liquid through tubing (22) as rollers (52) rotate along tubing (22) to provide accurate and precise dosing. Nozzle assembly (24) is in communication with pump (18) via tubing (22). These components may be secured together using fasteners (48) and tubing connectors (50). One such tubing connector (50a), disposed between dip tube (54) and pump (18), includes first and second portions (56, 58). First portion (56) includes a drip free connection, and second portion (58) includes a drip free connection. Drip free connections are sealed at opposing terminal ends to prevent leaks when connections are disconnected. The sealable valves prevent leaks of the fluid onto components of fluid dispenser (10). Stepper motor (20) is configured to provide power to pump (18).

As shown in FIGS. 2-4, fluid source (14) is in communication with pump (18). Fluid source (14) contains a supply of fluid. In some versions, the fluid may include hand sanitizer, while in other versions the fluid includes hand soap. The hand sanitizer or hand soap may be dispensed in liquid or foam forms. As shown, fluid source (14) includes a fluid cartridge (62) and a cap (64). Fluid cartridge (62) includes first and second openings (66, 68). Fluid cartridge (62) provides a refillable sanitizer cartridge in the present example. Fluid cartridge (62) is configured to allow for quick exchange of fluid cartridge (62), prevent drips, and make refilling fluid cartridge (62) mess free. First opening (66) is sized to prevent spilling while filling fluid cartridge (62), even without the use of a funnel. First opening (66) includes a first threaded coupling (70), and cap (64) includes a second threaded coupling (72) configured to couple with first threaded coupling (70) of fluid cartridge (62). Cap (64) includes at least one pressure release aperture (74) (three shown) that prevents collapse of fluid cartridge (62) as fluid is dispensed from fluid cartridge (62). Second opening (68) is configured to receive an elongate dip tube (54).

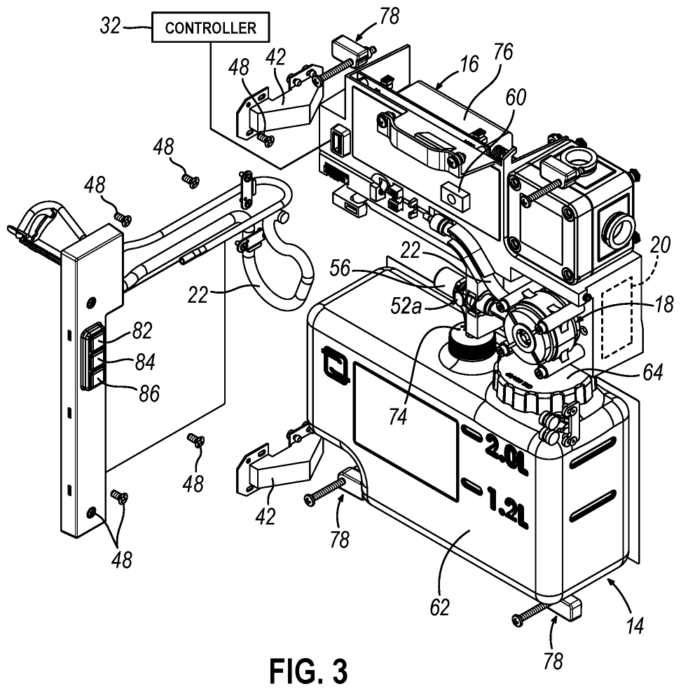

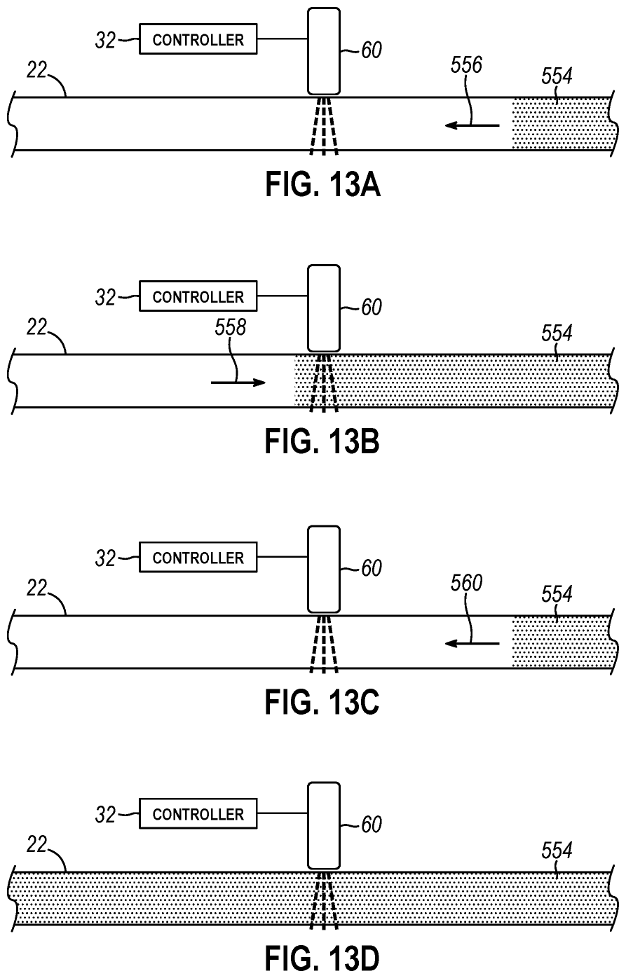

As shown in FIG. 3, an optional optical sensor (60), is configured to detect bubbles in a transparent tubing portion of tubing (22) to indicate a low fluid level of fluid source (14). For example, optical sensor (60) may be utilized to determine an empty sanitizer level without a maintenance person physically contacting fluid dispenser (10). One such suitable optical sensor (60) is a OPB350 tube liquid sensor commercially available from OPTEK Technology, Inc. As will be described below with reference to FIGS. 13A-13D, optical sensor (60) includes an infrared sensor that transmits infrared light through a transparent tubing portion of tubing (22). The spectrum detected on the other side of tubing (22) changes if no fluid is present. This may trigger an empty fluid warning. However, in some versions, fluid dispenser (10) does not stop attempting the dispense cycles until optical sensor (60) detects empty. This may account for incomplete fills or overfills by the user. For example, controller (32) may be configured prevent dispensing of the fluid in response to low fluid level sensed by optical sensor (60). Fluid levels between full and low may be determined using a separate mechanism. Every refill cycle may reset the fluid level to completely full. For example, a user may reset the counter by actuating second button (84). In some versions, fluid dispenser (10) may count dispense cycles, and thus the fluid dispensed volume. This may then be translated into fluid level feedback between full and low levels.

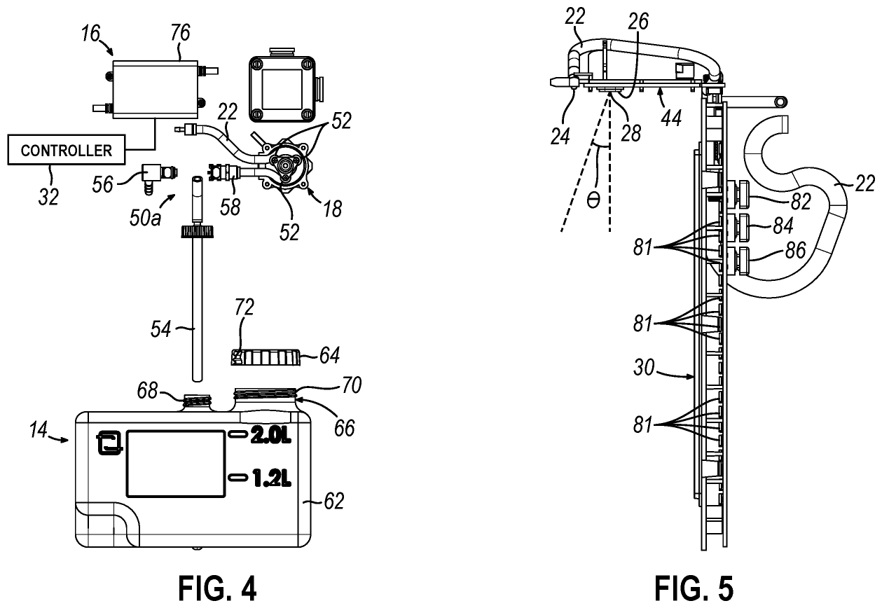

As shown in FIGS. 3-4, power source (16) may include a battery (76) configured to provide power to stepper motor (20) to drive pump (18) to move the fluid to the nozzle assembly (24). Alternatively, while not shown, fluid dispenser (10) may be plugged into an AC power outlet, hardwired to the electrical power line of the building in which fluid dispenser (10) is installed, or utilize Power over Ethernet (PoE) that passes electric power through Ethernet cabling. Having fluid dispenser (10) plugged into an AC power outlet or hardwired may obviate the need to manually replace batteries, thereby preventing a potential maintenance burden. As shown in FIGS. 2, 3, and 6, fluid dispenser (10) may include at least one coupling feature, shown as tightening members (78). Tightening members (78) are configured to couple with a member (80) of cavity (34) to secure fluid dispenser (10) with cavity (34). In the standard configuration, tightening members (78) on receptacle (40) are deployed and tightened with a drill in order to pinch against cavity (34) of wall (36) and secure fluid dispenser (10) therein. Tightening members (78) include each include a threaded fastener (88) and a threaded member (90). Threaded member (90) moves toward and away from a head (92) of threaded fastener (88) based on the direction of rotation of the threaded fastener (88).

As shown in FIG. 5, display (30) may include a linear RGB screen that activates a drip display. As shown, display (30) includes a plurality of light emitting diodes, LEDs (81). Front panel (38) may include a plurality of programmable buttons, with first, second, and third, buttons (82, 84, 86) being shown. First button (82) may be actuated to adjust the lighting mode by changing the light provided by LEDs (81) of display (30). Second button (84) may be actuated to refill fluid dispenser (10). Second button (84) may also be actuated to initiate a self-cleaning mode that may aid a user when refilling fluid cartridge (62). For example, second button (84) may be actuated once to perform an auto-cleaning mode to clean fluid dispenser (10). This may automatically cause pump (18) to draw the fluid back into fluid cartridge (62). Second button (84) may be actuated a second time to prime fluid dispenser (10) after unplugging fluid cartridge (62) when LEDs (81) turn yellow and replacing or refilling fluid cartridge (62).

Third button (86) may be actuated to place fluid dispenser (10) in a sleep mode; and may be actuated a second time to resume dispensing. Sleep mode may allow for cleaning or other maintenance of fluid dispenser (10). The sleep mode may allow for display (30) to continue displaying message(s); but prevent the fluid from being dispensed. This may be beneficial when a maintenance person or other user is interacting with fluid dispenser (10) and does not desire to have fluid dispensed. Fluid dispenser (10) may empty all of the residual fluid from tubing back into fluid cartridge (62) upon initiation of sleep mode. In some versions, an internal counter (not shown) may be automatically reset; while in other versions, third button (86) may be actuated and held for a predetermined time to reset the internal counter of fluid dispenser (10). The internal counter may be used to determine a volume of usable fluid remaining in fluid cartridge (62). Upon priming of fluid dispenser (10), optical sensor (60) may be used to position the leading edge of the fluid so that fluid dispenser (10) is ready for the first dispensing. For example, the leading edge of fluid may be placed adjacent to optical sensor (60), or the leading edge of the fluid may be located within nozzle assembly (24), so that the fluid is ready to be dispensed. Instructions for use may be displayed to the maintenance person or other user, such as on a decal on an inner surface of front panel (38) or otherwise.

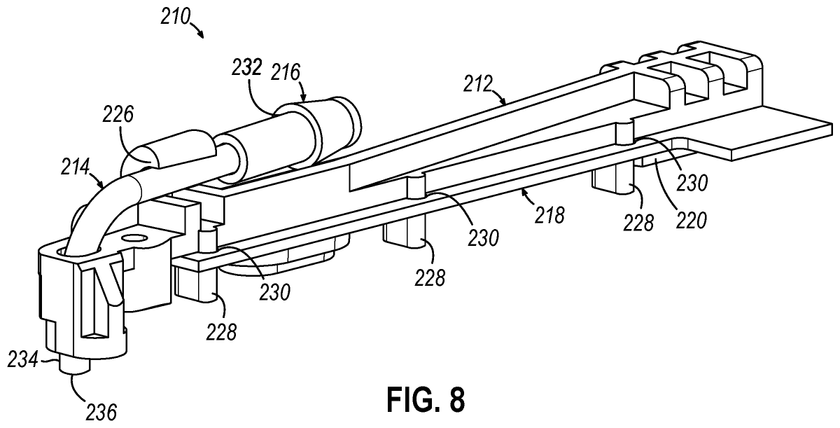

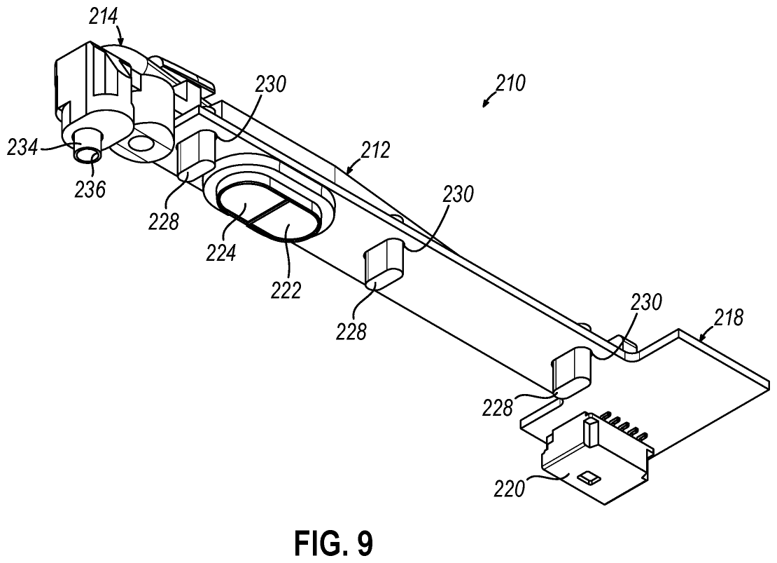

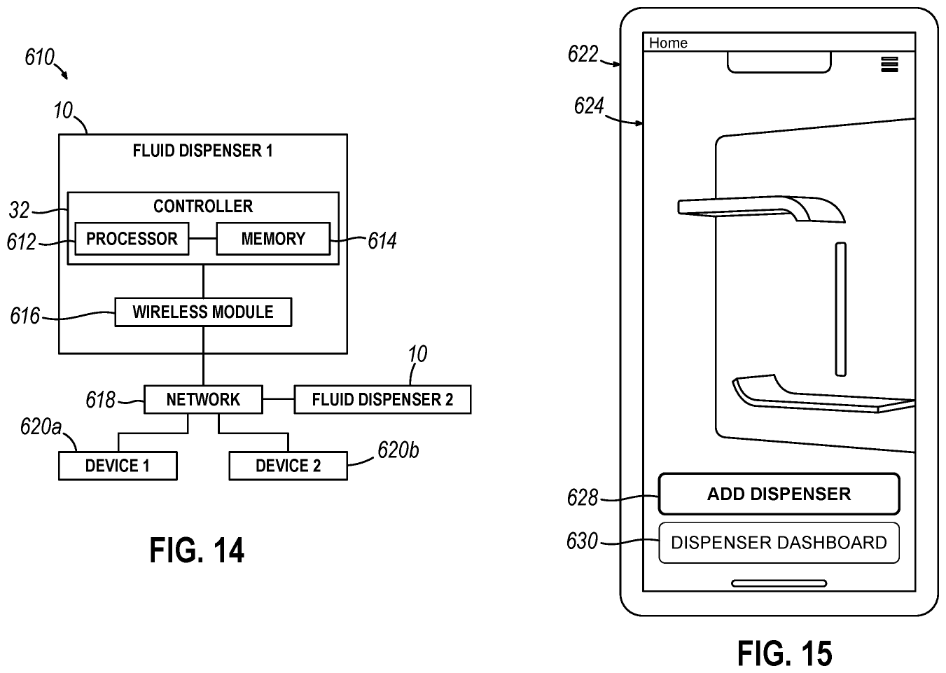

Controller (32) is in communication with pump (18), near field laser range finder (26), far field laser range finder (28), and optical sensor (60). Controller (32) may additionally provide remote monitoring of service intervals as described below with reference to FIGS. 14-16, where a wireless module (616) may allow for remote tracking of fluid level and maintenance. These service intervals may include replacement of the pump head, fluid remaining, the amount of fluid being utilized, battery life, and/or other service intervals. Further functionality of controller (32) is described below with reference to FIGS. 8 and 9.

Near and far field laser range finders (26, 28) are shown in FIG. 1 (schematically) and in FIG. 5. In some versions, near and far field laser range finders (26, 28) may include infrared laser range sensors. As shown, near and far field laser range finders (26, 28) aim vertically downwards. Near field laser range finder (26) is configured to sense a presence of an object within a predetermined distance away from near field laser range finder (26). One such suitable near field laser range finder (26) is a VL53L0CXV0DH Time-of-Flight (ToF) Ranging Sensor commercially available from STMicroelectronics NV. In some versions, near field laser range finder (26) may be used to detect when drip tray (46) is dirty (e.g., when fluid and/or some other substance accumulates on drip tray (46)). For example, near field laser range finder (26) may detect when drip tray (46) is dirty by a change in the reflectivity of drip tray (46) and/or a difference in the sensed distance between near field laser range finder (26) and drip tray (46). In some such cases, appropriate personnel may be automatically notified to clean drip tray (46). Other functionality of near field laser range finder (26) is described further below with reference to FIG. 8.

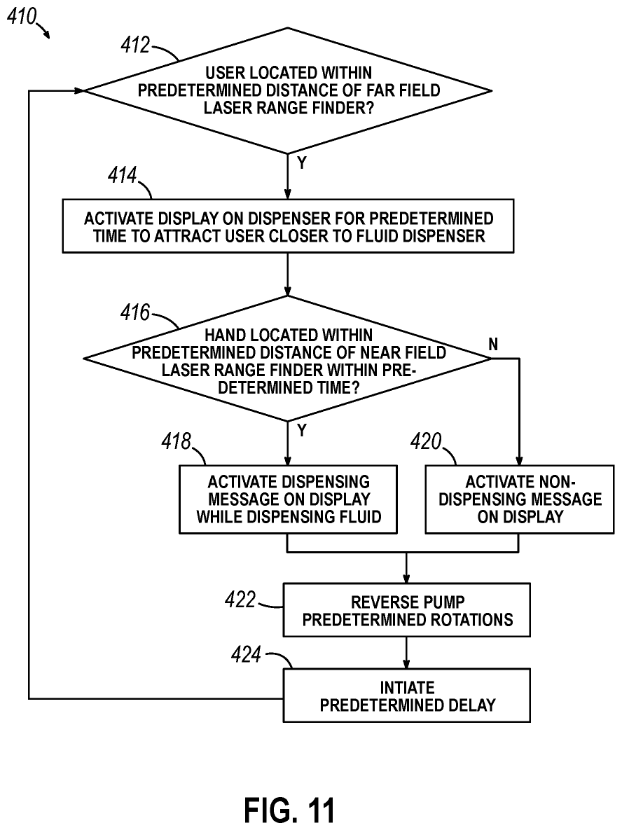

Far field laser range finder (28) is configured to sense a presence of a user at a distance that is greater than the distance sensed by near field laser range finder (26). Far field laser range finder (28) senses a user passing by and attracts them to use fluid dispenser (10), as will be described in greater detail below with reference to FIG. 11. Far field laser range finder (28) may be configured to detect the presence of people or objects within a predetermined angular range (0). As shown in FIG. 5, the predetermined angular range is less than about 25 degrees from vertical in front of fluid dispenser (10). In some versions, the use of an infrared laser range finder allows for users only to be detected within a narrow beam (e.g., less than about 25 degrees) in front of fluid dispenser (10). Incorporating an infrared laser range finder may allow for darker skin tones to be recognized. This allows for detection of only passing users, while minimizing noise (false positives) from ambient movement within the space. Far field laser range finder (28) works in conjunction with display (30). One such suitable near field laser range finder (26) is a VL53L0CXV0DH Time-of-Flight (ToF) Ranging Sensor commercially available from STMicroelectronics NV. The functionality of far field laser range finder (28) is described further below with reference to FIG. 11.

B. Second Exemplary Fluid Dispenser

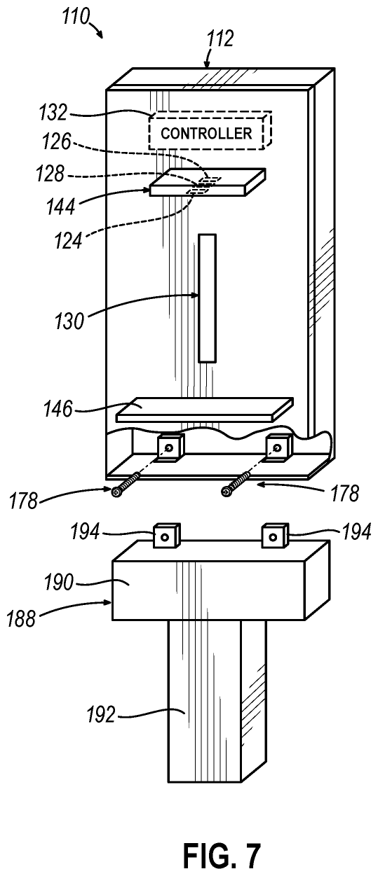

A second exemplary fluid dispenser (110) is schematically shown in FIG. 7. Fluid dispenser (110) is similar to fluid dispenser (10) described above with reference to FIG. 1-6. Similar to fluid dispenser (10), fluid dispenser (110) includes a body (112), a nozzle assembly (124), a near field laser range finder (126), a far field laser range finder (128), a display (130), a controller (132), an arm (144), and a drip tray (146).

Body (112) is configured to be mounted on a stand (188). Body (112) may include a cap (not shown). Stand (188) includes an upper enclosure (190) and a base (192). As shown, body (112) of fluid dispenser (110) may include at least one coupling feature, shown as tightening members (178). Tightening members (178) may tighten, pinch, and align body (112) of fluid dispenser (110) with upper enclosure (190). Upper enclosure (190) of stand (188) includes at least one coupling feature, shown as rigid members (194). Rigid members (194) are configured to couple with tightening members (178) to align body (112) with stand (188).

C. Second Exemplary Nozzle Assembly

FIGS. 8-9 show perspective views of another example of a nozzle assembly (210) that may be incorporated into fluid dispenser (10) in place of nozzle assembly (24) described above. Nozzle assembly (210) includes a carrier (212), a nozzle (214), a nozzle connector (216), a circuit board (218), an electrical connector (220), a near field laser range finder (222), and a far field laser range finder (224). Carrier (212) includes a clip (226) configured to receive nozzle (214). Carrier (212) includes projections (228) that are received by apertures (230) of circuit board (218).

Nozzle (214) includes opposing proximal and distal ends (232, 234). Nozzle connector (216) fluidly couples proximal end (232) with tubing (22). Fluid is dispensed to nozzle (214) from tubing (22). Nozzle (214) is shown as a metal tube that eliminates crevices to reduce the effect of dried fluid forming around and within distal end (234). Distal end (234) of nozzle (214) may include a sharp tip (236) that is configured to reduce the effect of dried fluid forming around and within second end (234). Over time, without sharp tip (236), dried solution may otherwise reduce the inner diameter of nozzle (214) and affect the ability of the fluid to be dispensed therethrough. For example, a partially clogged distal end (234) may reduce the usable inner diameter of nozzle assembly (24), which may cause the fluid to be dispensed at a variety of angles. Dispensing the fluid at a variety of angles may cause the fluid to not be dispensed in the expected location or quantity. For example, this may prevent the fluid from being entirely captured by the hand(s) of the user. Providing sharp tip (236), or otherwise configuring nozzle (214) to avoiding the formation of dried fluid, may thus provide consistent, predictable dispensation of fluid over repeated uses of fluid dispenser (10).

D. First Exemplary Method of Use

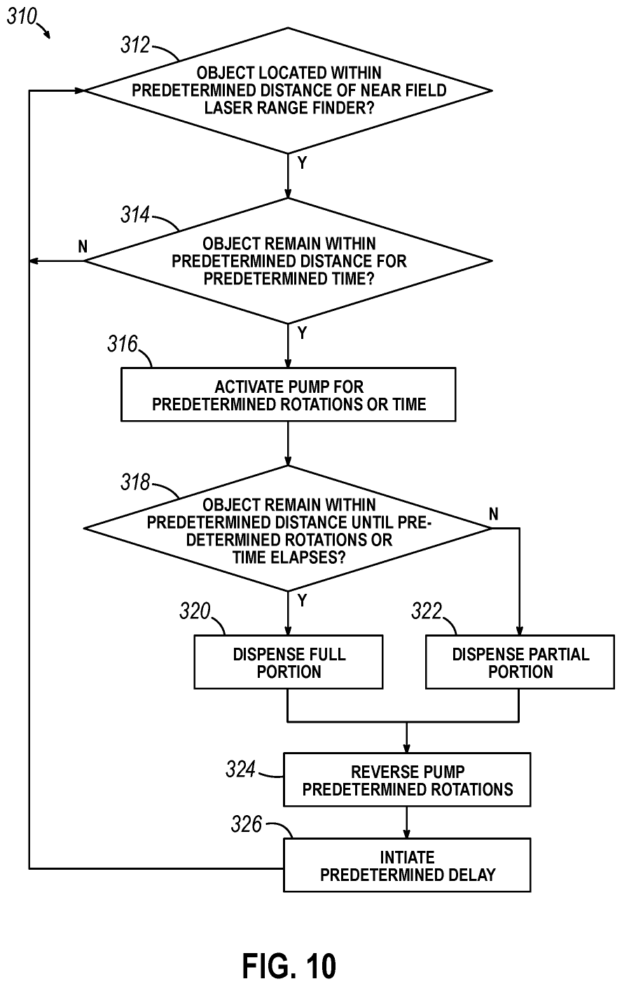

A method (310) of operating a fluid dispenser (10) is described with reference to FIG. 10. While method (310) is described with reference to fluid dispenser (10), method (310) also applies to fluid dispenser (110). At step (312), method (310) includes sensing the presence of an object (e.g., a hand of a user) within a predetermined distance away from near field laser range finder (26) of fluid dispenser (10) using near field laser range finder (26). In some versions, the predetermined distance may be about 150 millimeters; however, this distance may vary. If no object is sensed by near field laser range finder (26), sensing continues.

Conversely, in response to sensing the presence of the object, at step (314), method (310) includes determining that the object remains within the predetermined distance (being captured by near field laser range finder (26)) for a first predetermined amount of time using controller (32). This may increase the likelihood that the object initially sensed desires the fluid from fluid dispenser (10). In some versions, the predetermined time may be about 100 milliseconds; however, this time may vary. Particularly, hand placement under arm (44) is sensed using near field laser range finder (26).

In response to determining the object remains within the predetermined distance for the first predetermined amount of time, at step (316), method (310) includes activating pump (18) of fluid dispenser (10) for a second predetermined amount of time or for a predetermined number of rotations. This predetermined number of rotations may be a predetermined number of rotations of pump (18), which may in turn provide dispensation of a predetermined volume of fluid based on the number of rotations. In some versions, the predetermined number of rotations may be about 10 rotations; however, this number of rotations may vary. Dispensing may be achieved by operating pump (18) (e.g., a calibrated peristaltic pump) using stepper motor (20). Stepper motor (20) moves in a forward direction (clockwise or counterclockwise) for a predetermined number of degrees to dispense the fluid.

At step (318), method (310) includes controller (32) determining if the object remains within the predetermined distance of the near field laser range finder (26) until the completion of the predetermined amount of time or a predetermined number of rotations. At step (320), if the object remains within the predetermined distance of the near field laser range finder (26) for the entire predetermined amount of time or the predetermined number of rotations, the full volume is fluid is dispensed. However, at step (322), if the object does not remain within the predetermined distance of near field laser range finder (26) for the entire predetermined amount of time or the predetermined number of rotations, the dispensing terminates prior to the predetermined amount of time or a predetermined number of rotations. As a result, only a partial portion of the full volume is fluid is dispensed.

At step (324), method (310) includes reversing operation of pump (18) for a second predetermined number of rotations to reduce fluid from being dispensed. In some versions, the second predetermined number of rotations may be about 3 rotations; however, this number of rotations may vary. Reversing operation of pump (18) may be performed using stepper motor (20) as instructed by controller (32). After dispensing is complete or terminated prematurely, stepper motor (20) switches to a reverse direction (the other of clockwise or counterclockwise) for a predetermined number of degrees to reduce or altogether eliminate unintended drips between uses. The reverse direction is opposite to the forward direction. This reversing of stepper motor (20) effectively pulls at least some of the fluid back into fluid dispenser (10) that may otherwise unintentionally drip out of nozzle assembly (24) onto drip tray (46) or the floor. Particularly, if the user's hand moves away from fluid dispenser (10) before the dispensing cycle completes, then pump (18) immediately reverses to prevent unintended drips. This utilizes the fast action of pump (18) (shown as a peristaltic pump) and stepper motor (20), based on the sensing from near field laser range finder (26).

After reversing operation of pump (18), at step (326), method (310) includes delaying for a second predetermined amount of time. In some versions, the second predetermined amount of time may be about 500 milliseconds; however, this time may vary. In some versions, if fluid dispenser (10) is not utilized for a predetermined amount of time (e.g., 9 hours), controller (32) may reverse operation of pump (18) using stepper motor (20) to retract the fluid to a position before (i.e., upstream) of the rollers (52) of pump (18). This may prevent evaporation and drying of the fluid in tubing (22). Upon activation of pump (18), at step (316), the fluid may be moved to nozzle assembly (24) for subsequent dispensing.

E. Second Exemplary Method of Use

A method (410) of operating a fluid dispenser (10) that includes far field laser range finder (28) and display (30) is described with reference to FIG. 11. While method (310) is described with reference to fluid dispenser (10), method (310) also applies to fluid dispenser (110). At step (412), method (410) includes sensing a presence of a user within a predetermined distance away from far field laser range finder (28) of fluid dispenser (10) using far field laser range finder (28). In some versions, the predetermined distance may be about 0 to about 3 meters; however, this distance may vary. For example, since the sensing of far field laser range finder (28) is limited by angle (0) as described above, the predetermined distance that far field laser range finder (28) senses is also limited. Far field laser range finder (28) may thus detect the presence of potential users who are standing or passing by fluid dispenser (10) within a certain distance of fluid dispenser (10); but who are not necessarily planning on utilizing fluid dispenser (10).

At step (414), method (410) includes activating display (30) on fluid dispenser (10) for a predetermined amount of time, to attract the user to the display (30). In some versions, the predetermined time may be about 5 seconds. To attract the user, display (30) may show a drip display on a linear red, green, and blue (RGB) screen. Alternatively, display (30) may show any other suitable text and/or graphics to try to attract the user to interact with fluid dispenser (10). In the event that the user moves closer to fluid dispenser, at step (416), method (410) includes sensing the hand of the user located within a second predetermined distance from near field laser range finder (26). The first predetermined distance is greater than the second predetermined distance.

In response to sensing the hand of the user located within the second predetermined distance from near field laser range finder (26), at step (418), method (410) includes activating dispensing message on display (30) while dispensing fluid from nozzle assembly (24) of fluid dispenser (10). After completing step (418), at step (422), method (410) includes reversing operation of pump (18) for a second predetermined number of rotations to reduce fluid from being dispensed, similar to step (324). At step (424), method (410) includes initiating a predetermined delay.

Conversely, in response to not sensing the hand of the user located within the second predetermined distance from near field laser range finder (26) at step (416), method (410) includes activating a non-dispensing message on display (30) at step (420). For example, this non-dispensing message may include a yellow triple flash on display (30). After step (420) of activating the non-dispensing message, method (410) may initiate the predetermined delay at step (424). In some versions, the predetermined delay at step (424) may be about 3 seconds, after which a user may reactivate fluid dispenser (10) as described above in step (412) using far field laser range finder (28).

F. Third Exemplary Method of Use

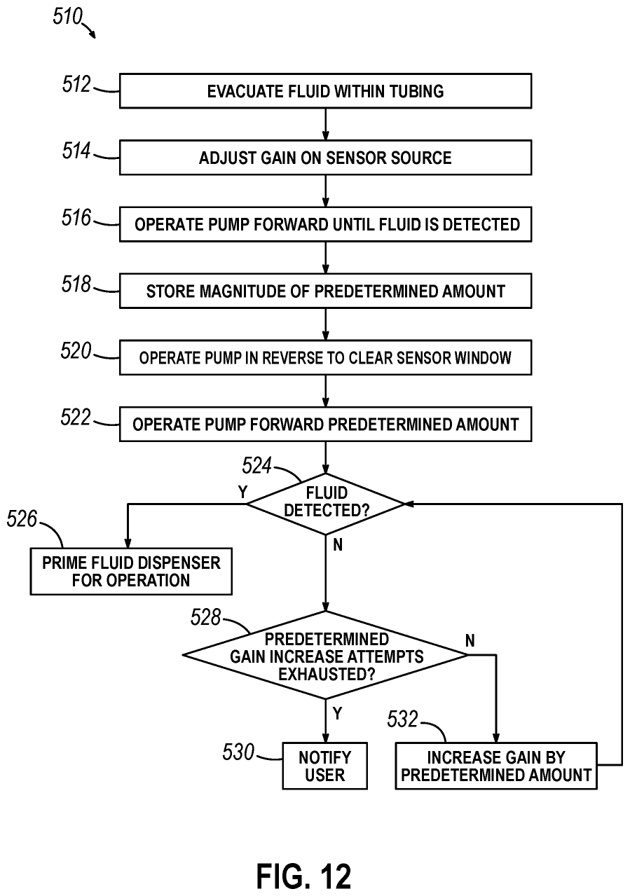

An exemplary method (510) of calibrating fluid dispenser (10) is shown and described with reference to FIG. 12 and FIGS. 13A-13D. While method (510) is described with reference to fluid dispenser (10), method (410) also applies to fluid dispenser (110). Method (510) includes steps (512, 514, 516, 518, 520, 522, 524, 526, 528, 530); however, more or fewer steps are also envisioned. Method (510) may allow fluid dispenser (10) to pull fluid (554) back into fluid dispenser (10), so that optical sensor (60) may identify fluid (554).

At step (512), upon startup of fluid dispenser (10), controller (32) may instruct stepper motor (20) to operate pump (18) in reverse to evacuate fluid from tubing (22). This clears any residual fluid from tubing (22). In some versions, tubing (22) may be optically transmissive so that optical sensor (60) may obtain an unobstructed view of fluid (554) through tubing (22). In other versions (e.g., where tubing (22) is not optically transmissive), an optically transmissive tubing segment (not shown) may be interposed between terminal ends of tubing (22) and thereby be in fluid communication with tubing (22), with optical sensor (60) being positioned at this optically transmissive tubing segment, so that optical sensor (60) may obtain an unobstructed view of fluid (554). At step (514), controller (32) may instruct optical sensor (60) to adjust the gain on optical sensor (60) to a point just prior to reaching detection. In other words, increasing the gain on optical sensor (60) may increase the sensitivity of optical sensor (60). This may minimize, or altogether negate, effects caused by variations in the optical transmissivity of tubing (22) due to manufacturing variability, aging, etc.

At step (516), controller (32) may instruct stepper motor (20) to operate pump (18) in the forward direction until fluid (554) is detected by optical sensor (60). This movement of fluid (554) is shown in FIG. 13A using arrow (556). Optical sensor (60) may determine whether fluid is contained in a sensed portion of tubing (22) or if a sensed portion or tubing (22) does not contain fluid, through feedback of optical sensor (60). Optical sensor (60) may sense infrared light on the opposing side of tubing (22) (i.e., opposite the optical sensor (60) as shown), which may indicate that fluid is present in tubing (22) as the fluid (554) may absorb the infrared light. At step (518), controller (32) may store calibration value(s) obtained from optical sensor (60) in a memory (see FIG. 15). The calibration value may include the predetermined amount (e.g., time or number of revolutions) the motor or pump is operated forward for fluid to be sensed by optical sensor (60). At step (520), controller (32) may instruct stepper motor (20) to operate pump (18) in reverse to clear portion (552) of tubing (22) sensed by optical sensor (60). This is shown in FIG. 13B using arrow (558). As a result, optical sensor (60) no longer senses fluid being present in tubing (22).

At step (522), controller (32) may instruct stepper motor (20) to operate pump (18) in the forward direction the predetermined amount as determined in step (516) and stored in step (518). This is shown in FIG. 13C using arrow (558). At step (524), controller (32) determines whether fluid (554) is detected using optical sensor (60). If fluid (554) is detected by optical sensor (60), at step (526), controller (32) may prime fluid dispenser (10) for operation. If fluid (554) is not detected by optical sensor (60), at step (528), controller (32) may determine whether the predetermined number of attempts to detect fluid has been exhausted. If the predetermined number of attempts to detect fluid has been exhausted, at step (530), controller (32) notifies the maintenance person or other user that the predetermined number of attempts to detect fluid (544) has been exhausted. For example, controller (32) may to notify the maintenance person or other user by illuminating display (30) or producing a sound (e.g., using a speaker (not shown)). If the predetermined number of attempts to detect fluid has not been exhausted, controller (32) may increase the gain of optical sensor (60) by a predetermined amount. In some versions, this predetermined gain increase may be about 10%. However, other predetermined gain increases are also envisioned.

G. Exemplary System

FIG. 14 shows a diagrammatic view of an exemplary system (610) that includes one or more fluid dispensers (10) of FIG. 1. As described above, fluid dispenser (10) includes controller (32). Controller (32) may include a processor (612) and memory (614). Controller (32) may be in communication with a wireless module (616). In some versions, each fluid dispenser (10) may include wireless module (616). Wireless module (616) may be disposed within fluid dispenser (10) or be placed at a position capable of interacting with one or more fluid dispensers (10). In some versions, wireless module (616) may attach to a main circuit board (not shown) of controller (32). The association of controller (32) and wireless module (616) may allow maintenance persons (e.g., facility managers) or other users to determine when particular fluid dispensers (10) should be refilled or serviced, without necessarily needing to physically approach each fluid dispenser (10) in person.

Wireless module (616) may be in communication with a network (618). Network (618) may include a wired network or a wireless network (e.g., a WiFi network). Network (618) may communicate with at least one device (shown as first and second devices (620a, 620b)). For example, a maintenance person or other user may add fluid dispensers (10) onto network (618) using an application (622) (FIG. 15) for devices (620a, 620b). Devices (620a, 620b) may include wireless communication devices (e.g., smartphones, tablets, and/or smart watches) and/or personal computers (e.g., laptops and/or desktops). Application (622) may be stored in a cloud (e.g., on a remote server). Wireless module (616) may coordinate refills and/or maintenance using application (622) to assist maintenance persons or other users with their workflow. In some versions, wireless module (616) may instruct controller (32) to adjust the predetermined amount of fluid (554) dispensed to tailor each fluid dispenser (10) according to preferences of that space's primary occupants (e.g., children as compared to adults) or to account for personal preferences. For example, children may warrant a smaller volumetric dose as compared to adults who may warrant a larger volumetric dose.

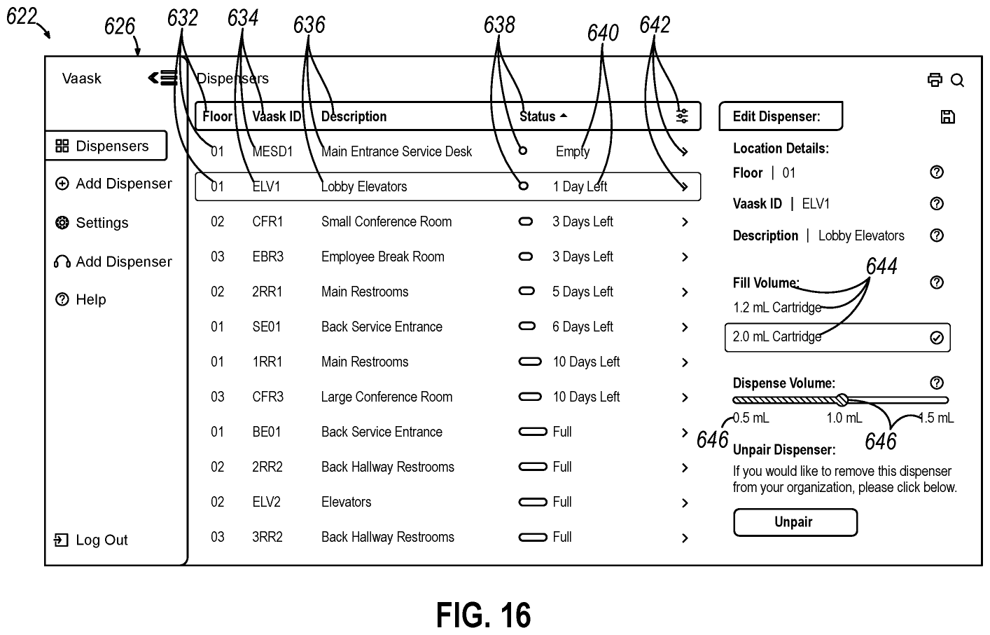

FIGS. 15 and 16 show first and second exemplary interfaces (624, 626) of application (622). In interface (624), a maintenance person may select “add dispenser” (628) or may select “dispenser dashboard” (630). Interface (626) includes columns for floor (632), unique identifier (ID) (634), description (636), status graphic (638), estimated remaining period (640), and an edit option (642). Edit option (642) allows a maintenance person to adjust information, including fill volume (644) and dispense volume (646). Maintenance persons or other users may benefit through use of system (610) for management of fluid dispensers (10). For example, maintenance persons or other users may save time and the associated expense by only servicing fluid dispensers (10) when needed. System (610) may ensure fluid dispensers (10) are functional, reducing likelihood of spreading illness in the facility. Application (622) may sort tens or thousands of fluid dispensers (10) based on location and service needs.

II. Exemplary Combinations

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A fluid dispenser comprising: (a) a pump configured to receive fluid from a fluid source; (b) a motor configured to provide power to the pump; (c) a nozzle in communication with the pump; (d) a near field sensor configured to sense a presence of an object within a first predetermined distance away from the near field sensor; and (e) a controller in communication with the pump and the near field sensor, wherein the controller is configured to: (i) determine the presence of the object within the first predetermined distance for a first predetermined amount of time, (ii) in response to the determination, activate the pump for a second predetermined amount of time or for a first predetermined number of rotations to push the fluid in a first direction and dispense the fluid to a user, (iii) determine an absence of the object within the first predetermined distance of the near field sensor prior to completion of the second predetermined amount of time or the first predetermined number of rotations, and (iv) reverse operation of the pump for a second predetermined number of rotations to draw the fluid back toward the fluid source in a second direction that is opposite the first direction in the absence of the object within the predetermined distance of the near field sensor.

### Example 2

The fluid dispenser of Example 1, further comprising a far field sensor configured to sense a presence of the user at a second predetermined distance that is greater than the first predetermined distance.

### Example 3

The fluid dispenser of Example 2, wherein the far field sensor is configured to detect a range of less than about 25 degrees from vertical in front of the fluid dispenser.

### Example 4

The fluid dispenser of any one or more of Examples 2 through 3, further comprising: (a) a panel; and (b) an arm extending from the panel, wherein the nozzle, the near field sensor, and the far field sensor are each disposed on the arm.

### Example 5

The fluid dispenser of any one or more of Examples 2 through 4, wherein the near field sensor and the far field sensor are oriented to aim vertically downwards.

### Example 6

The fluid dispenser of any one or more of Examples 2 through 5, wherein the far field sensor includes a far field laser range finder.

### Example 7

The fluid dispenser of any one or more of the preceding Examples, wherein the near field sensor includes a near field laser range finder.

### Example 8

The fluid dispenser of any one or more of the preceding Examples, wherein the motor is a stepper motor.

### Example 9

The fluid dispenser of any one or more of the preceding Examples, further comprising a display configured to show a message to the user.

### Example 10

The fluid dispenser of Example 9, wherein the message is one of a dispensing message, a non-dispensing message, or a low fluid warning.

### Example 11

The fluid dispenser of any one or more of the preceding Examples, wherein the tubing includes a transparent tubing portion, the fluid dispenser further comprising: (a) the fluid source; and (b) an optical sensor configured to detect bubbles in the transparent tubing portion to indicate a low fluid level of the fluid source.

### Example 12

The fluid dispenser of Example 11, wherein the controller is configured prevent dispensing of the fluid in response to low fluid level sensed by the optical sensor.

### Example 13

The fluid dispenser of any one or more of the preceding Examples, further comprising an ethernet cable configured to provide power to the fluid dispenser.

### Example 14

The fluid dispenser of Examples 1 through 12, further comprising an ethernet cable configured to provide power to the motor to move the fluid to the nozzle.

### Example 13

The fluid dispenser of Examples 1 through 12, further comprising a battery configured to provide power to the motor to move the fluid to the nozzle.

### Example 16

The fluid dispenser of any one or more of the preceding Examples, further comprising at least one coupling feature configured to couple with a member of a wall cavity to secure the fluid dispenser with the wall cavity.

### Example 17

The fluid dispenser of any one or more of the preceding Examples, further comprising (a) at least one coupling feature; and (b) a stand that includes at least one ledge configured to couple with the at least one coupling feature to align the head unit with the stand.

### Example 18

The fluid dispenser of any one or more of the preceding Examples, further comprising the fluid source that is in communication with the pump, wherein the fluid source comprises: (a) a fluid cartridge that includes a coupling, and (b) a cap that includes a coupling configured receive the coupling of the fluid cartridge.

### Example 19

The fluid dispenser of Example 16, wherein the cap includes at least one pressure release aperture.

### Example 20

The fluid dispenser of any one or more of the preceding Examples, wherein the nozzle includes a sharp distal end configured to minimize blockage of dried fluid.

### Example 21

The fluid dispenser of any one or more of the preceding Examples, wherein at least a distal portion of the nozzle is metal that is configured to eliminate crevices to reduce the effect of dried fluid.

### Example 22

A system comprising: (a) any one or more of the preceding Examples; and (b) a wireless module operatively coupled with the fluid dispenser and configured to interact with a network, wherein the wireless module is configured to determine a status of the fluid dispenser remotely.

### Example 23

The system of Example 22, wherein the controller is configured to adjust the predetermined amount using the wireless module.

### Example 24

The system of Examples 22 through 23, further comprising an application in communication with the wireless module configured to allow the status of the of the fluid dispenser to be remotely accessed.

### Example 25

The system of Examples 22 through 24, further comprising a display configured to display the status, wherein the status is an estimation of the time remaining until there is insufficient fluid to operate the fluid dispenser.

### Example 26

A fluid dispenser comprising: (a) a fluid source; (b) a pump configured to receive fluid from a fluid source; (c) a tubing in communication with the pump; (d) an optical sensor; and (e) a controller in communication with the pump and the optical sensor, wherein the controller includes a memory, wherein to calibrate the optical sensor the controller is configured to: (i) operate the pump in a first direction to draw the fluid back toward the fluid source, (ii) adjust a gain of the optical sensor to a magnitude just prior to detection by the optical sensor with the tubing being empty, (iii) operate the pump in a second direction that is opposite the first direction until the fluid is detected by the optical sensor, (iv) store a magnitude of the gain in the memory, (v) operate the pump in the first direction, and (vi) operate the pump in the second direction by the predetermined amount.

### Example 27

The fluid dispenser of Example 26, wherein the controller is configured to: (a) determine that the fluid is not detected in the tubing based on feedback received from the optical sensor, and (b) in response to the fluid not being detected, increase a magnitude of the gain.

### Example 28

The fluid dispenser of Example 27, wherein the controller is configured to increase the magnitude of the gain a predetermined number of times in response to the fluid not being detected.

### Example 29

The fluid dispenser of Example 28, wherein the controller is configured to notify the user after exceeding the predetermined number of times.

### Example 30

The fluid dispenser of any one or more of Examples 26 through 29, wherein the controller is configured to: (a) determine that the fluid is detected in the tubing based on feedback received from the optical sensor, and (b) in response to the fluid being detected, position the leading edge of the fluid at a predetermined position.

### Example 31

A method of operating a fluid dispenser comprising: (a) sensing a presence of an object within a predetermined distance away from a near field sensor of the fluid dispenser using the near field sensor; (b) in response to the sensing, determining that the object remains within the predetermined distance for a first predetermined amount of time; (c) in response to the determination, activating a pump of the fluid dispenser for a second predetermined amount of time or for a predetermined number of rotations push the fluid in a first direction and dispense the fluid to a user; (d) determining an absence of the object within the predetermined distance of the near field sensor prior to completion of the predetermined amount of time or a predetermined number of rotations; and (e) reversing operation of the pump for a second predetermined number of rotations to draw the fluid back toward the fluid source in a second direction that is opposite the first direction in the absence of the object within the predetermined distance of the near field sensor.

### Example 32

The method of Example 31, wherein reversing operation of the pump further comprises reversing operation of the pump using a motor.

### Example 33

The method of Example 32, wherein the motor is a stepper motor.

### Example 34

The method of any one or more of Examples 31 through 33, further comprising after reversing the operation of the pump, sensing a second object within the predetermined distance of the near field sensor.

### Example 35

The method of any one or more of Examples 31 through 34, further comprising after reversing the operation of the pump, delaying for a second predetermined amount of time.

### Example 36

The method of Example 35, further comprising after delaying for the second predetermined amount of time, sensing a second object within the predetermined distance of the near field sensor.

### Example 37

The method of Example 35, further comprising after delaying for the second predetermined amount of time, further drawing the fluid back toward the fluid source in the second direction to a predetermined position

### Example 38

The method of Example 37, wherein the pump is a peristaltic pump that includes at least one roller, wherein the predetermined position is upstream of the at least one roller.

### Example 39

The method of any one or more of Examples 31 through 38, wherein the object is a hand of a user.

### Example 40

The method of any one or more of Examples 31 through 39, wherein the near field sensor includes a near field laser range finder.

### Example 41

A method of operating a fluid dispenser comprising: (a) sensing a presence of a user within a predetermined distance away from a far field sensor of the fluid dispenser using the far field sensor; (b) activating a display on the fluid dispenser to attract the user to the display; (c) sensing a hand of the user located within a second predetermined distance from a near field sensor, wherein the first predetermined distance is greater than the second predetermined distance; and (d) dispensing fluid from a nozzle of the fluid dispenser in response to sensing the hand of the user by the near field sensor.

### Example 42

The method of Example 41, further comprising actuating a button to perform a cleaning routine prior to refilling the fluid dispenser with fluid.

### Example 43

The method of any of Examples 41 through 42, wherein sensing the presence of the user further comprises sensing the presence of the user within a range of less than about 25 degrees from vertical in front of the fluid dispenser using the far field sensor.

### Example 44

The method of any of Examples 41 through 43, wherein the far field sensor includes a far field laser range finder.

### Example 45

The method of any of Examples 41 through 44, wherein the near field sensor includes a near field laser range finder.

### Example 46

A method of operating a fluid dispenser comprising: (a) sensing a presence of an object within a predetermined distance away from a near field sensor of the fluid dispenser using the near field sensor; (b) in response to the sensing, determining that the object remains within the predetermined distance for a first predetermined amount of time; (c) in response to the determination, activating a pump of the fluid dispenser for a second predetermined amount of time or for a predetermined number of rotations push the fluid in a first direction and dispense the fluid to a user; (d) determining an absence of the object within the predetermined distance of the near field sensor prior to completion of the predetermined amount of time or a predetermined number of rotations; and (e) reversing operation of the pump for a second predetermined number of rotations to draw the fluid back toward the fluid source in a second direction that is opposite the first direction in the absence of the object within the predetermined distance of the near field sensor.

### Example 47

A method of operating a fluid dispenser comprising: (a) operating a pump in a first direction to draw a fluid toward a fluid source that is fluidly coupled with the pump using tubing; (b) resetting a counter; and (c) positioning the leading edge of the fluid at a predetermined position.

### Example 48

A method of operating a fluid dispenser comprising: (a) sensing a hand of the user located within a predetermined distance from a near field sensor; (b) dispensing fluid from a nozzle of the fluid dispenser in response to sensing the hand of the user by the near field sensor; and (c) sensing that a drip tray of the fluid dispenser is dirty using the near field sensor.

### Example 49

The method of Example 48, wherein the sensing is based on at least one of a change in the reflectivity of the drip tray or a difference in a sensed distance between the near field sensor and the drip tray.

### III. Miscellaneous

It should be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

I/We claim:

1. A fluid dispenser comprising:
(a) a pump configured to receive fluid from a fluid source;
(b) a motor configured to provide power to the pump;
(c) a nozzle in communication with the pump;
(d) a near field sensor configured to sense a presence of an object within a first predetermined distance away from the near field sensor; and
(e) a controller in communication with the pump and the near field sensor, wherein the controller is configured to:
(i) determine the presence of the object within the first predetermined distance for a first predetermined amount of time,
(ii) in response to the determination, activate the pump for a second predetermined amount of time or for a first predetermined number of rotations to push the fluid in a first direction and dispense the fluid to a user,
(iii) determine an absence of the object within the first predetermined distance of the near field sensor prior to completion of the second predetermined amount of time or the first predetermined number of rotations, and
(iv) reverse operation of the pump for a second predetermined number of rotations to draw the fluid back toward the fluid source in a second direction that is opposite the first direction in the absence of the object within the predetermined distance of the near field sensor.

2. The fluid dispenser of claim 1, further comprising a far field sensor configured to sense a presence of the user at a second predetermined distance that is greater than the first predetermined distance.

3. The fluid dispenser of claim 2, wherein the far field sensor is configured to detect a range of less than about 25 degrees from vertical in front of the fluid dispenser.

4. The fluid dispenser of claim 2, further comprising:
(a) a panel; and
(b) an arm extending from the panel, wherein the nozzle, the near field sensor, and the far field sensor are each disposed on the arm.

5. The fluid dispenser of claim 1, wherein the motor is a stepper motor.

6. The fluid dispenser of claim 1, further comprising a display configured to show a message to the user.

7. The fluid dispenser of claim 1, wherein the tubing includes a transparent tubing portion, the fluid dispenser further comprising:
(a) the fluid source; and
(b) an optical sensor configured to detect bubbles in the transparent tubing portion to indicate a low fluid level of the fluid source.

8. The fluid dispenser of claim 1, further comprising an ethernet cable configured to provide power to the motor to move the fluid to the nozzle.

9. The fluid dispenser of claim 1, wherein the nozzle includes a sharp distal end configured to minimize blockage of dried fluid.

10. The fluid dispenser of claim 1, wherein at least a distal portion of the nozzle is metal that is configured to eliminate crevices to reduce the effect of dried fluid.

11. The fluid dispenser of claim 1, further comprising a wireless module operatively coupled with the fluid dispenser and configured to interact with a network, wherein the wireless module is configured to determine a status of the fluid dispenser remotely.

12. The fluid dispenser of claim 11, wherein the controller is configured to adjust the predetermined amount using the wireless module.

13. The fluid dispenser of claim 12, further comprising an application in communication with the wireless module configured to allow the status of the of the fluid dispenser to be remotely accessed.

14. A fluid dispenser comprising:
(a) a fluid source;
(b) a pump configured to receive fluid from a fluid source;
(c) a tubing in communication with the pump;
(d) an optical sensor; and
(e) a controller in communication with the pump and the optical sensor, wherein the controller includes a memory, wherein to calibrate the optical sensor the controller is configured to:
(i) operate the pump in a first direction to draw the fluid back toward the fluid source,
(ii) adjust a gain of the optical sensor to a magnitude just prior to detection by the optical sensor with the tubing being empty,
(iii) operate the pump in a second direction that is opposite the first direction until the fluid is detected by the optical sensor,
(iv) store a magnitude of the gain in the memory,
(v) operate the pump in the first direction, and
(vi) operate the pump in the second direction by the predetermined amount.

15. The fluid dispenser of claim 14, wherein the controller is configured to:
(a) determine that the fluid is not detected in the tubing based on feedback received from the optical sensor, and
(b) in response to the fluid not being detected, increase a magnitude of the gain.

16. The fluid dispenser of claim 15, wherein the controller is configured to increase the magnitude of the gain a predetermined number of times in response to the fluid not being detected.

17. The fluid dispenser of claim 14, wherein the controller is configured to:
(a) determine that the fluid is detected in the tubing based on feedback received from the optical sensor, and
(b) in response to the fluid being detected, position the leading edge of the fluid at a predetermined position.

18. A method of operating a fluid dispenser comprising:
(a) sensing a presence of an object within a predetermined distance away from a near field sensor of the fluid dispenser using the near field sensor;
(b) in response to the sensing, determining that the object remains within the predetermined distance for a first predetermined amount of time;
(c) in response to the determination, activating a pump of the fluid dispenser for a second predetermined amount of time or for a predetermined number of rotations push the fluid in a first direction and dispense the fluid to a user;
(d) determining an absence of the object within the predetermined distance of the near field sensor prior to completion of the predetermined amount of time or a predetermined number of rotations; and
(e) reversing operation of the pump for a second predetermined number of rotations to draw the fluid back toward the fluid source in a second direction that is opposite the first direction in the absence of the object within the predetermined distance of the near field sensor.

19. The method of claim 18, further comprising sensing that a drip tray of the fluid dispenser is dirty using the near field sensor.

20. The method of claim 19, wherein the sensing is based on at least one of a change in the reflectivity of the drip tray or a difference in a sensed distance between the near field sensor and the drip tray.
